(19) United States
(12) Patent Application Publication
(10) Pub. No.: US 2002/0165759 A1
(43) Pub. Date: Nov. 7, 2002

(54) Method and system for efficient communication and relationship management

(76) Inventors: Harry E. Gruber, Rancho Santa Fe, CA (US); Yun Deng, San Diego, CA (US); Jeane S. Chen, San Diego, CA (US); Joyce T. Abela, San Diego, CA (US)

Correspondence Address: KINTERA INC., 9605 SCRANTON ROAD, SUITE 240, SAN DIEGO, CA, 92121, US

(21) Appl. No.: 09/848,101

(22) Filed: May 3, 2001

(51) Int. Cl. G06F 17/60

(52) U.S. Cl. 705/10

(57) ABSTRACT

A computer-implemented method and system for efficient communication among a patient and family and friends is provided. The invention identifies charitable organizations that the patient and his friends and family may be inclined to support and establishes relationship between them and the charitable organizations. These organizations include hospitals and other healthcare facilities, research organizations, or other charitable and nonprofit organizations. The invention then solicits charitable donations. In accordance with one embodiment of the invention, there is provided a method for efficient communication and relationship management, the method establishing relationship between the patient, friends and family and one or more charitable organizations and soliciting charitable donations, the method utilizing a computer system linked to a network, the computer system having one or more processors, one or more storage devices coupled to the processors, comprising providing one or more message boards having information about the patient, providing an online visitation calendar illustrating scheduled visits to the patient, asking one or more questions to identify likes and dislikes of the patient and friends and family, identifying charitable organizations based on the indicated preferences and dislikes, and soliciting a charitable donation for the charitable organizations. The method further provides one or more types of message boards, wherein the message boards are accessed using a username and a password.

### FIELD OF THE INVENTION

The present invention relates to communication and relationship management. More specifically, the invention relates to a method and system that provides efficient communication among a patient, family, friends, religious leaders, doctors and nurses, identifies charitable organizations that they may be inclined to support, establishes relationship between the patient, friends and family and the charitable organizations, surveys participants and solicits charitable donation from the participants.

### BACKGROUND OF THE INVENTION

As is well known, relatives and friends of a patient often like to communicate among themselves about the patient. They like to discuss the patient's condition, treatment, and other matters related to the patient's health. Also, they like to visit the patient and send greetings or other messages. They also like to get updated information about the patient's condition.

Communications among the patient's friends and family may occur during personal visits to the patient or through phone calls. They may also occur during personal visits among themselves. While personal visits are typically the best way to communicate and to get updated information about the patient's condition, they are sometimes not possible. Friends and family, for example, may reside out of town. They may be too busy to take the time to make personal visits. Often, friends and family need to get a quick update on the patient's condition. Phone calls to the patient, family member and doctor are often not convenient. The patient may not be in a condition to receive calls. Phone calls are often expensive, especially long-distance calls. A relative or a friend that desires to keep others informed of the patient's condition may find that there are too many people to contact by phone or through personal visits.

When friends and family call the hospital to get an update on the patient's condition, the hospital staff is often unsure of what type of information they should disclose. They may not be certain, for example, if a particular caller is a close family member of the patient or a mere friend. They are often uncertain whether the caller is a legitimate friend or a family member. Also, there is often an uncertainty as to how much information can be properly disclosed to a caller. A close family member may be entitled to confidential information about the patient's condition. In contrast, a friend may be entitled to less confidential information. Even when a caller identifies himself as a friend or a family member, the hospital is often uncertain as to how much information the caller is entitled to receive. Thus, the hospital staff is often in a difficult situation where they are forced to make decisions as to how much information to disclose.

Friends and family who desire to make personal visits to the patient must set a schedule. Personal visits to the patient must be set depending on the patient's condition, hospital hours and other scheduled visitations. Personal visits may be allowed when the patient is well enough to receive visitors. Moreover, they are often allowed during hospital visitation hours only. Furthermore, a visitor may want to visit the patient when there are no other visitors. For example, a close family member may wish to see the patient alone. In those cases, the visitor must work with the hospital staff and the patient to determine the optimum time for such a visit. Also, this creates an additional burden on the hospital to coordinate a schedule.

When patients are treated at a hospital or other healthcare facility for some disease, the patients as well as their friends and family often take a more personal interest in the disease. They often demonstrate an interest to learn more about the disease. A patient, for example, receiving cancer treatment may be interested in learning more about cancer. The patient's family and friends may also take an interest in learning more about cancer. They may also be interested in learning more about cancer treatment and any ongoing research to find cures for cancer. Consequently, it is likely that they may be inclined to support facilities that provide cancer treatment and support research to find cures for the disease. They may be inclined to make donations to charitable, nonprofit and other organizations that provide such treatment and support such research and development. Thus, there exists an opportunity to develop a relationship between the patient and his friends and family and the charitable organizations involved in treating as well as finding a cure for the disease. This relationship between the patient and his friends and family and the charitable organizations may lead to immediate as well as long-term financial support for the organizations.

For the foregoing reasons, there is a need for a method and system that allows patients and their friends and family to efficiently communicate among themselves. More specifically, there is a need for a method and system that allows friends and family to send and receive messages, and otherwise communicate among themselves. There is a need for a method and system that allows friends and family to get updates of the patient's condition. There is a need for a method and system that ensures privacy so that only those that are allowed to receive confidential information regarding the patient have access to such information.

Furthermore, there is a need for an automated method and system that simplifies visitation procedures to the patient consistent with a hospital's visitation hours. More specifically, there is a need for a method and system that allows friends or family to conveniently schedule a visit.

There is also a need for a method and system that identifies preferences and dislikes of the patients and their friends and family. There is a need for a method and system that identifies charitable organizations that they may be inclined to support based on their preferences and dislikes. There is a need for a method and system that establishes a relationship between the patient and his friends and family and one or more charitable organizations. There is a need for a system and method that solicits a charitable donation.

### SUMMARY OF THE INVENTION

The present invention addresses these and other problems by providing a computer-implemented method and system for efficient communication among a patient and family and friends. The invention identifies charitable organizations that the patient and his friends and family may be inclined to support and establishes relationship between them and the charitable organizations. These organizations include hospitals and other healthcare facilities, research organizations, or other charitable and nonprofit organizations. The invention then solicits charitable donations.

In accordance with one embodiment of the invention, there is provided a method for efficient communication and relationship management, the method establishing relationship between the patient, friends and family and one or more charitable organizations and soliciting charitable donations, the method utilizing a computer system linked to a network, the computer system having one or more processors, one or more storage devices coupled to the processors, comprising providing one or more message boards having information about the patient, providing an online visitation calendar illustrating scheduled visits to the patient, asking one or more questions to identify likes and dislikes of the patient and friends and family, identifying charitable organizations based on the indicated preferences and dislikes, and soliciting a charitable donation for the charitable organizations.

The method further provides one or more types of message boards, wherein the message boards are accessed using a username and a password. The method further provides a patient message board that is accessed by the patient, a doctor's message board that is accessed by the doctor and/or the nurse, a family message board that is accessed by family members, a relatives' message board that is accessed by relatives and a friends' message board that is accessed by friends. The method provides privacy by ensuring that only authorized persons have access to the message boards.

The method further comprises the step of editing the visitation calendar to update scheduled visits. The method comprises identifying charitable organizations by surveying participants and soliciting a charitable donation. The method further comprises the step of receiving a pledge for charitable donations. The method further comprises the step of receiving payment in support of a charitable organization.

### BRIEF DESCRIPTION OF THE DRAWINGS

These and other features of the invention will now be described with reference to the drawings summarized below. These drawings and the associated description are provided to illustrate various embodiments of the invention, and not to limit the scope of the invention.

FIG. 1 illustrates a system level diagram in accordance with one embodiment of the invention.

FIG. 2 is a flow diagram of the method steps for accessing the message boards.

FIG. 3 is a flow diagram of the method steps of surveying participants and soliciting a charitable donation.

### DETAILED DESCRIPTION OF THE INVENTION

The present invention provides a solution to the above-mentioned problems. Briefly stated, the invention provides an efficient communication and relationship management method and system. The invention allows a patient's friends and family to efficiently communicate among themselves and with the patient, send and receive messages, schedule visits, and support charitable organizations and causes. The invention allows friends and family to conveniently get updates on the patient's condition. The invention ensures privacy so that only those that are allowed to receive confidential information regarding the patient have access to such information. The invention also simplifies visitation procedures to the patient.

Furthermore, the invention identifies the patient's and his friends' and family's preferences and their dislikes. By asking one or more questions, the invention seeks to identify what they liked and did not like about the hospital, the treatment, the doctor, or any other matter related to the patient and the treatment. The preferences and dislikes are used to identify charitable causes and other organizations that the patient, friends and family may be inclined to support. The organizations may be the hospital, one or more departments within the hospital, any organizations affiliated with the hospital, or any organization supported by the hospital. The invention identifies charitable causes that are related to the indicated preferences, as well as charitable causes that are related to the indicated dislikes.

Consider, for example, a scenario where a patient receives medical treatment at a hospital. Consider further that the patient specifically receives cardiac care as well as radiology treatment. If the patient indicates that he was highly satisfied with the cardiac care at a hospital, then he is asked whether he would like to make a donation to the cardiology department of the hospital.

If, on the other hand, the patient indicates that he was dissatisfied with the radiology treatment at the hospital, he may be asked to make suggestions to improve the radiology facility. Furthermore, he may be asked to make a donation that would be used to make improvements to the radiology department. Thus, the invention solicits donation from a person by identifying his satisfactions as well as dissatisfactions.

The invention establishes a relationship between the patient and his friends and family and one or more charitable causes or organizations. According to the invention, a hospital that provided medical treatment to a patient may seek a donation for itself, or, more specifically, for one of its department. The hospital may also seek a donation for a charitable organization that it is affiliated with.

In one aspect, the invention is a web-enabled system comprising one or more interactive web pages. The system is linked to a wide area network, such as the world wide web of the Internet. A user may access the web pages using an appropriate URL. The web pages allow the user to send and receive messages, schedule visits to the patient, and get an update of the patient's condition. The web pages also allow the patient and his friends and family to indicate likes and dislikes regarding treatment and the healthcare facility. The web pages also provide information about organizations and various causes that they may be inclined to support.

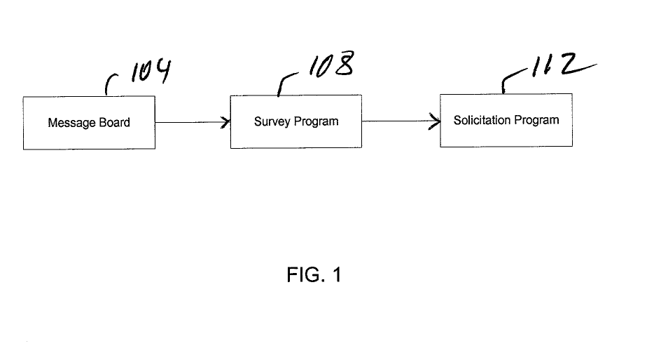

FIG. 1 illustrates a system level diagram in accordance with one embodiment of the invention. Referring now to FIG. 1, the invention in one aspect comprises one or more message boards 104, a survey program 108 and a solicitation program 112.

In one embodiment, there are several types of message boards, each type designated for a class of users. The message boards are secured, and are only accessed by users having authorized username and passwords.

For example, the invention provides a patient message. The patient message board includes, among others, messages sent to the patient by others and a visitation calendar. The patient's message board may include a doctor's report related to the patient's condition and any ongoing treatment. This information is considered privileged and can be accessed by the patient, the doctor, and other persons approved by the patient.

The patient message board allows the patient to communicate with friends and family without the need for personal visits or phone calls. The patient message board allows the patient to reply to the messages. The patient message board includes a visitation calendar illustrating scheduled visits to the patient. The visitation calendar complies with the hospital visitation hours.

The invention provides a family message board for family members with valid authorization. The family message board allows family members to efficiently communicate among themselves. The family message board typically includes confidential information about the patient's condition. It may even include very sensitive information about the patient's condition that may not even be included in the patient's message board. For example, there may be certain information about the patient's condition that will adversely affect the patient's physical or mental condition, and such information may be shared with close family members but will be withheld from the patient.

Like the patient's message board, the family message board allows the family members to send and receive messages, get updates on the patient's condition, and schedule visits. The members can exchange messages among themselves or with the patient. The members can view the visitation calendar and schedule visits to the patient consistent with hospital visitation hours.

The invention provides a doctors and nurses message board where the doctors or nurses can post messages related to the patient. This message board typically includes confidential information about the patient's condition, and they may be only accessible by the medical personnel and the patient. However, the doctors or the patient can allow close family members access to this message board.

In one embodiment, the message boards include a web page containing the patient's medical data. The medical data is considered confidential information and is generally accessible only by authorized medical personnel and the patient. The patient can, however, authorize selected family members to have access to the medical data.

The invention provides a relatives' message board for relatives with valid authorization. The information contained therein is less confidential in nature than that in the family message board. The relatives can access the visitation calendar to schedule visits. In one embodiment, the patient and the family members also have access to the relatives' message board.

The invention provides a friends' message board. The information contained herein is least confidential. For example, friends may not be privy to confidential information related to the patient's condition or the treatment. Also, friends may not have access to communications between the patient and family. The message board, however, allows the friends to send and receive messages from each other. Friends can access the visitation calendar to view scheduled visits or to schedule a visit. In one embodiment, the patient, family and relatives have access to the friends' message board.

In one embodiment, the invention includes a single message board having one or more pages. Each page is designated for a class of persons. A page, for example, may be designated as the family's page, and is accessible by family members only. Another page may be designated as the relatives' page, and is accessible by authorized relatives only. The pages perform substantially the same way as the message boards described before. However, instead of having a plurality of message boards, the invention can have a single message board comprising one or more pages. While an authorized person having a valid username and a password can access the message board, they can only access the designated page for that class of persons.

In one embodiment, the message boards include advertisements and other contents. The contents can be educational, commercial advertisements, banner ads, and promotional information related to products and services. The contents can be owned by the hospital or by other organizations and causes. For example, the message boards can feature pharmaceutical products, or information about a nursing home. The hospital can generate revenues by charging a fee for carrying a third-party content.

The message boards and the visitation calendar provide numerous benefits. Since the message boards are classified according to access privileges, the patient can be assured that only persons authorized to receive appropriate information has access. The hospital or the healthcare facility does not have to decide privacy issues such as whether a caller is authorized to receive confidential information. Visitation schedules are also shown in the calendar, thus simplifying visitation procedures and eliminating the need to contact the hospital for that information.

As noted before, an object of the invention is to identify charitable causes and organizations that the patient and his friends and family will be inclined to support. For example, if a patient is satisfied with the cardiac care at a hospital, he may be interested in making a donation to the cardiac department of the hospital. Also, if the patient is dissatisfied with radiology treatment at a hospital, he may be also be willing to make suggestions to improve the radiology facilities, and further make a donation that can be used to make improvements to the radiology facilities. Thus, a hospital can benefit by identifying the patient's preferences and dislikes, and then soliciting a charitable donation.

It is believed that when a patient receives medical treatment at a healthcare facility (e.g., hospital, outpatient facility), the patient and his friends and family are more interested in learning relevant treatments and about ongoing research and development to find cures for the disease. They may be interested in learning about charitable organizations that provide such treatments, and support funding for such research and development. These organizations may be affiliated with the hospital or may even be part of the hospital itself. They may be willing to make a donation to the cardiac department of the hospital. They may also be interested in learning about organizations that can provide support and care to the patient. They may, for example, be interested in learning about nursing homes, religious institutions and other organizations that provide support and care to similar patients. Consequently, there exists an opportunity to establish a relationship between the patient and his friends and family and one or more organizations and causes that may lead to immediate and long-term support.

The hospital may also sponsor or otherwise support other nonprofit organizations that are engaged medical treatment and research and development. The hospital can solicit donation for the benefit of those organizations or provide information about those organizations. The hospital may provide data to the organizations that can subsequently contact the patient, family or friends for a donation.

Referring again to FIG. 1, the system includes a comprehensive survey program 108 configured to conduct an online survey. The object of the survey program is to identify preferences and dislikes of the patient, his friends and family. The survey program identifies the preferences and dislikes by asking them one or more questions. The program identifies the preferences and dislikes from the answers.

A patient, for example, may be asked one or more of the following questions:

(1) What is your illness?

(2) What type of treatment did you receive?

(3) Were you satisfied or dissatisfied with the doctor?

(4) Did you like the hospital?

(5) Did you have surgery during your stay?

(6) Are you satisfied or dissatisfied with your surgery?

(7) Did you like the nurses?

(8) Did you like the food?

(9) How was radiology?

Consider, for example, a scenario where the patient received treatment for cancer and was satisfied with the treatment. In that case, the patient may be asked the following questions related to cancer research:

(1) Would you like additional information about cancer research?

(2) Would you like to make a donation to support the departments that treat cancer patients at this hospital?

(3) Would you like to receive information about charities that support cancer research?

(4) Would you like to make a charitable donation to support cancer research?

If, for example, the patient indicated that he was dissatisfied with the radiology treatment at the hospital, he may be asked to make suggestions for improvements of the radiology facility. Furthermore, he may be asked to make a donation to improve the radiology facilities at the hospital. The patient may be inclined to make a donation to improve the radiology facilities since that may benefit future patients.

Thus, the information from the survey is used to identify various causes and charities that the patient may be inclined to support. If the patient indicates that he is interested in more information on the causes and charities, then the patient is provided additional information. The patient's friends and family may also be asked similar questions to identify their preferences and dislikes, and then asked to make a donation. Based on their answers, they may be provided further information.

The information, for example, may include the following:

a. the type of activities the organizations are engaged in;

b. major breakthroughs in finding a cure for the disease;

c. the amount of money the organizations need each year to conduct the research;

d. the amount of money raised this year;

e. profiles of donors that have contributed to the organizations in the past.

The information is provided in order to encourage the patient and his friends and family to take an interest in the cause. For example, they are provided with information about other donors that have donated to the organizations. They may also view one or more virtual plaques recognizing the donors for their support. The virtual plaques are created to encourage other donors to support the organizations. The virtual plaques are described in detail in a co-pending application filed on Dec. 12, 2000, titled “SYSTEM AND METHOD FOR INTERACTIVE FUNDRAISING OVER A WIDE AREA NETWORK.” The subject matter of that application is incorporated herein by reference in its entirety.

In one embodiment, friends, family and relatives are sent a link to a patient-specific donor page. The patient specific donor page refers to a web page that may include, among others, a profile of the patient, information about the disease, ongoing research and development to find cures for the disease, charitable and nonprofit organizations engaged in such research, and other relevant information that encourages the recipient to take an interest in the cause. The web page may also include information on the amount of money needed to support such activities, the amount of money raised, the patient's fundraising goals, etc. The information is carefully selected to motivate the recipient to make a donation to the organizations.

In one aspect, the invention tends to establish a long-term relationship between the patient and his friends and family and the hospital (or other organizations). The long-term relationship makes it more likely that they will not only make a donation to the hospital, but will continue to support the hospital in the future. In the above scenario, for example, since the patient received cancer treatment, it is likely that they would be interested in more information about various cancer treatments. It is also likely that they would be willing to make a charitable donation in support of cancer treatment and other cancer related research at the hospital. Furthermore, once they make a donation in support of cancer treatment or research, it is likely that they would continue to support through future donations.

Referring back to FIG. 1, the system includes a solicitation program 112 that seeks charitable donations from the patient and his friends and family. Once the patient or his friends or family indicate an interest in more information about a cause, they are solicited to make a donation. They can make a pledge or make an outright donation.

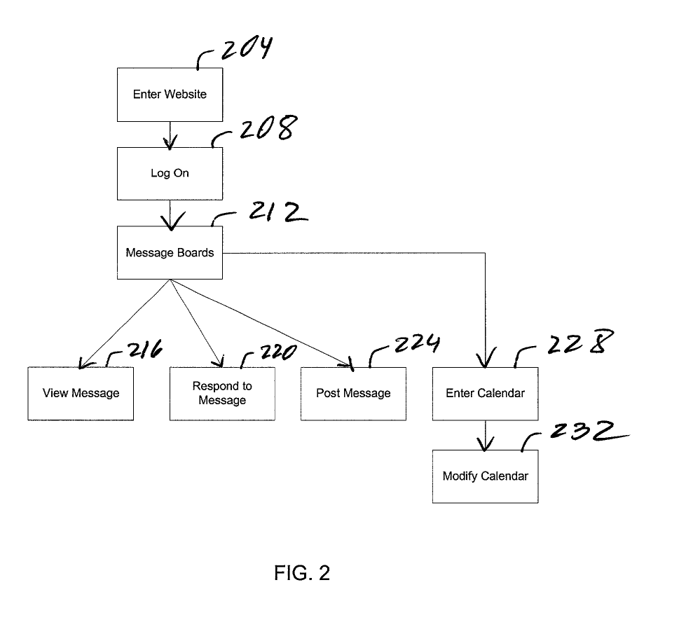

FIG. 2 is a flow diagram of the method steps for accessing the message boards in accordance with one embodiment of the invention. A user enters the website at step 204 using a valid URL.

In step 208, the user logs on to the system. The user uses a valid username and a password to logon to the system. In step 212, the user enters an authorized message board. As noted before, the user's password determines the message board the user can access. A patient, for example, can view messages 216, respond to messages 220, or post messages 224. The patient can access the visitation calendar 228, see the visitation schedules and edit, if necessary, the visitation calendar 232. The patient can view messages from the doctor or nurse, or messages and greetings from friends and family. Likewise, a family member can access a message board specifically set up for family members and communicate with other family members, friends or the patient. The family member can get updated information about the patient's condition.

On the other hand, a friend with a valid password can access the friends' message board that does not include confidential information, such as the patient's medical condition, the doctor's messages, etc. The friend, however, can communicate with the patient and other friends or family. The friend can also access the visitation calendar. Thus, the invention provides privacy by ensuring that only authorized persons have access to confidential information.

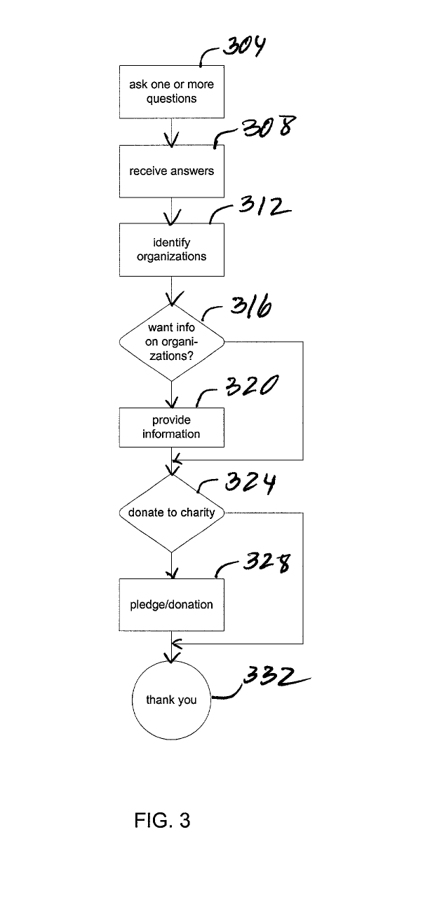

FIG. 3 is a flow diagram of the method steps of identifying the preferences and dislikes of the patient and his friends and family and soliciting a charitable donation. The method begins in step 304 where the patient or his friends or family is asked one or more questions. These questions may be related to the particular treatment received by the patient, their preferences and dislikes, or other questions that can help identify their interests.

In step 308, the answers are received, and in step 312, organizations are identified. The organizations can include, for example, the hospital itself, one or more departments of the hospital, or other organizations affiliated or otherwise supported by the hospital. In step 316, the patient or his friend or family member is asked if he would like information about the organizations. If he indicates that he would like information, in step 320 the he is provided with the information. The information includes a description of the organizations and the types of activities they are engaged in. The information may also include the amount of money the organizations need to raise, the amount already raised, the average amount of donation, information about other donors, and other relevant information.

In step 324, the patient, his friend or his family member is asked if he would like to make a charitable donation. If he wishes to make a donation, he is allowed to make a pledge or make an outright donation in step 328.

In one embodiment of the invention, the data is collected from the survey and is used for future solicitations. Unlike a patient's medical records, this data is typically not confidential since they relate to a person's preferences. Consequently, the data can be disclosed to other organizations so that they can effectively target potential donors. In one embodiment, the persons are asked to provide consent prior to their information being disclosed to the organizations.

Although the preferred embodiments have been described, it should be understood that various changes, substitutions, and alterations can be made herein without departing from the scope of the invention. Furthermore, it should be noted that the present invention can be implemented using virtually any computer system or other networking system and virtually any available programming language. Other examples of changes, substitutions, and alterations are readily ascertainable by one skilled in the art and could be made without departing from the spirit and scope of the present invention as defined by the following claims.

What is claimed is:

1. A method for efficient communication and relationship management, the method establishing relationship between a patient, friends or family and one or more organizations and soliciting charitable donations, the method utilizing a computer system linked to a network, the computer system having one or more processors, one or more storage devices coupled to the processors, comprising:
providing a web-based, online healthcare communication system;
asking one or more questions regarding preferences and dislikes of participants;
identifying organizations based on the answers to the questions; and
soliciting a charitable donation for the organizations.

2. The method according to claim 1, wherein the organization is a hospital.

3. The method according to claim 1, wherein the organization is a nonprofit organization.

4. The method according to claim 1, wherein the organization is a charitable organization.

5. The method according to claim 1, further comprising providing one or more message boards having information about a patient and messages from friends, family and the patient.

6. The method according to claim 1, further comprising providing one or more online visitation calendars illustrating scheduled visits to the patient.

7. The method according to claim 1, further providing one or more types of messages boards.

8. The method according to claim 1, wherein the message boards are accessed using a username and a password.

9. The method according to claim 1, further providing a patient message board that is accessed by the patient.

10. The method according to claim 1, further providing a family message board that is accessed by family members.

11. The method according to claim 1, further providing a relatives' message board that is accessed by relatives.

12. The method according to claim 1 further providing a friends' message board that is accessed by friends.

13. The method according to claim 1, wherein the message board includes messages from others.

14. The method according to claim 1, wherein the message board allows a user to reply to message.

15. The method according to claim 1, wherein the message board allows a user to post messages.

16. The method according to claim 1, further comprising editing the visitation calendar to update scheduled visits.

17. The method according to claim 1, further comprising receiving a pledge for charitable donations.

18. The method according to claim 1, further comprising receiving payment for a charitable donations.

19. A system for efficient communication and relationship management, the system establishing relationship between a patient, friends or family and one or more organization and soliciting donations, the system utilizing a computer system linked to a network, the computer system having one or more processors, one or more storage devices coupled to the processors, comprising:
a web-based, online communication service related to patient care;
a survey program for asking one or more questions regarding preferences and dislikes of participants, and for identifying organizations based on the answers to the questions; and
a solicitation program for seeking a donation for the organizations.

20. The system according to claim 19, wherein the organization is a hospital.

21. The system according to claim 19, wherein the organization is a charitable organization.

22. The system according to claim 19, wherein the organization is a nonprofit organization.

23. The system according to claim 19, further comprising one or more message boards having information about the patient and messages from friends, family and the patient.

24. The system according to claim 19, further comprising one or more visitation calendars illustrating scheduled visits to the patient;

25. The system according to claim 19, further comprising one or more types of messages boards.

26. The system according to claim 19, wherein the message boards are accessed using a username and a password.

27. The system according to claim 19, further comprising a patient message board that is accessed by the patient.

28. The system according to claim 19, further comprising a family message board that is accessed by family members.

29. The system according to claim 19, further comprising a relatives' message board that is accessed by relatives.

30. The system according to claim 19, further comprising a friends' message board that is accessed by friends.

31. The system according to claim 19, wherein the message boards include messages from others.

32. The system according to claim 19, wherein the message boards allow a user to reply to messages.

33. The system according to claim 19, wherein the message boards allow a user to post messages.

34. The system according to claim 19, wherein the visitation calendar is modified to update scheduled visits.

35. The system according to claim 19, further comprising means for receiving a pledge for charitable donations.

36. The system according to claim 19, further comprising means for receiving payment for a charitable donations.
